(19) United States
(12) Patent Application Publication
(10) Pub. No.: US 2011/0176021 A1
(43) Pub. Date: Jul. 21, 2011

(54) Image-Processing Integrated Circuit

(75) Inventors: Tse Ming Chu, Taipei City (TW); Ma Sung Chuan, Taoyuan County (TW)

(73) Assignee: MAO BANG ELECTRONIC CO., LTD., Taoyuan County (TW)

(21) Appl. No.: 12/908,078

(22) Filed: Oct. 20, 2010

(30) Foreign Application Priority Data
Jan. 21, 2010 (TW) 099201251

(51) Int. Cl. H04N 5/228

(52) U.S. Cl. 348/222.1

(57) ABSTRACT

An image-processing integrated circuit includes an image-processing die, a conductive layer, first optical units and a second optical unit. The conductive layer is provided on a face of the image-processing die. The first optical units are provided on an opposite face of the image-processing die. The second optical unit is provided on the first optical units.

### BACKGROUND OF INVENTION

1. Field of Invention

The present invention relates to an image-processing integrated circuit and, more particularly, to a small image-processing integrated circuit that can be made independent of a circuit board at a high yield.

2. Related Prior Art

To make an image-processing integrated circuit, sensors of R, G and B cells are made on a wafer to define dies on the wafer. Then, the wafer is cut into dies. First optical units are formed on a face of each of the dies before each of the dies is electrically connected to a substrate such as a circuit board or a silicon substrate by COB or WLCSP. Finally, a second optical unit is provided on the first optical units. Thus, the image-processing integrated circuit is made and can be used to process images.

However, in the foregoing process, the die must be electrically connected to the substrate. Hence, the foregoing process is complicated. Moreover, the size of the resultant imaging integrated circuit is big. In addition, the yield of the foregoing process is low.

The present invention is therefore intended to obviate or at least alleviate the problems encountered in prior art.

### SUMMARY OF INVENTION

It is the primary objective of the present invention to provide a small image-processing integrated circuit that can be made independent of a circuit board at a high yield.

To achieve the foregoing objective, the image-processing integrated circuit includes an image-processing die, a conductive layer, first optical units and a second optical unit. The conductive layer is provided on a face of the image-processing die. The first optical units are provided on an opposite face of the image-processing die. The second optical unit is provided on the first optical units.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a side view of an image-processing integrated circuit according to the preferred embodiment of the present invention;

FIG. 2 is a side view of a conductive layer attached to a face of a die of the image-processing integrated circuit shown in FIG. 1;

FIG. 3 is a side view of first optical units attached to an opposite face of the die shown in FIG. 2; and

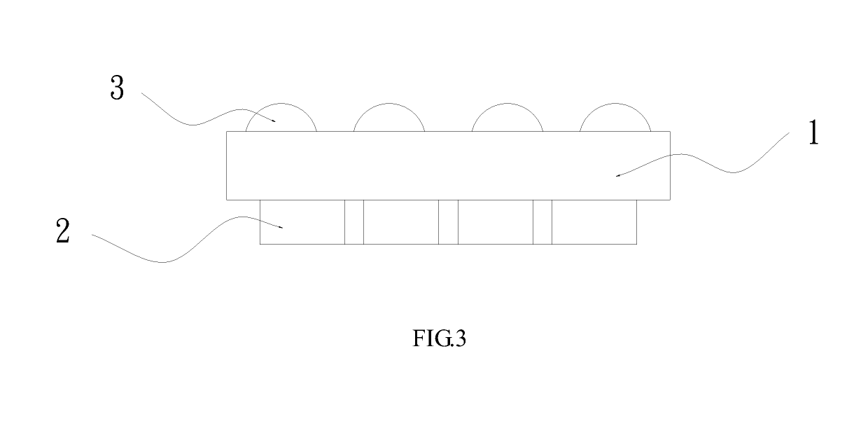

FIG. 4 is a side view of a second optical unit attached to the first optical units shown in FIG. 3.

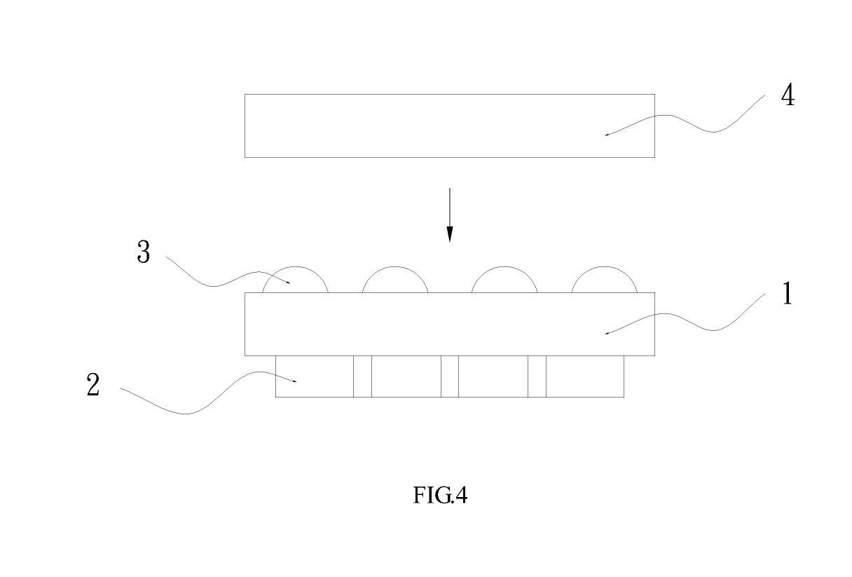

### DETAILED DESCRIPTION OF PREFERRED EMBODIMENT

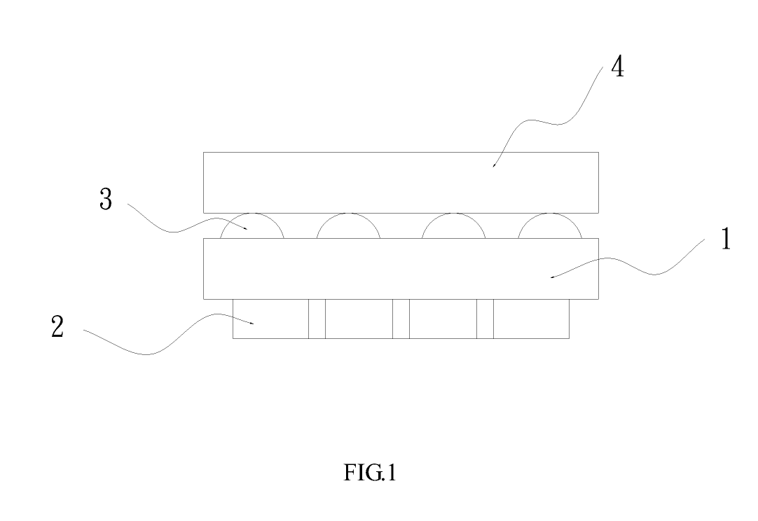

Referring to FIG. 1, there is shown an image-processing integrated circuit according to the preferred embodiment of the present invention. The image-processing integrated circuit includes an image-processing die 1, a conductive layer 2 attached to a first face of the image-processing die 1, first optical units 3 attached to an opposite second face of the image-processing die 1, and a second optical unit 4 attached to the first optical units 3.

The image-processing die 1 can be COMOS sensor or a CCD sensor for example.

The conductive layer 2 is used for wiring. The conductive layer 2 is not used as a layout of the image-processing die 1.

The first optical units 3 are convex lenses, concave lenses or Fresnel lenses.

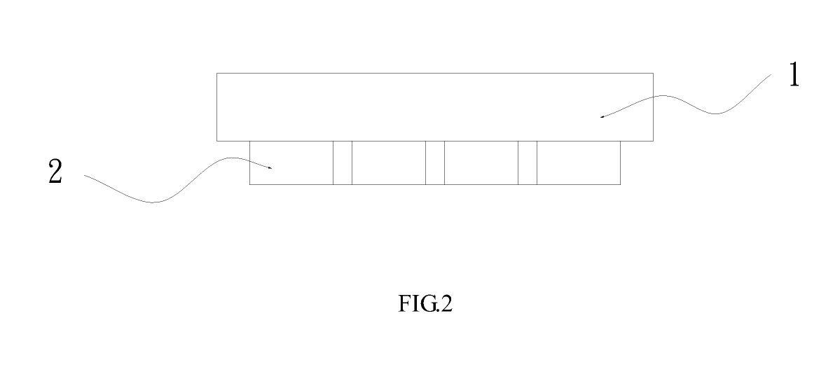

To make the image-processing integrated circuit, referring to FIG. 2, sensors such as R, G and B cells are formed on a wafer (not shown) to define dies on the wafer. Then, the wafer is cut into image-processing dies 1. The conductive layer 2 is formed on the first face of each of the image-processing dies 1 by a through-silicon via technique for example. The first optical units 3 are provided on the second face of each of the image-processing dies 1. Finally, the second optical unit 4 is provided on the first optical units 3. Thus, the image-processing integrated circuit can be made independent of any circuit board at a high yield. Moreover, the size of the image-processing integrated circuit is small.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An image-processing integrated circuit comprising:
an image-processing die 1;
a conductive layer 2 provided on a face of the image-processing die 1;
first optical units 3 provided on an opposite face of the image-processing die 1; and
a second optical unit 4 provided on the first optical units 3.

2. The image-processing integrated circuit according to claim 1, wherein the image-processing die 1 is a COMOS sensor.

3. The image-processing integrated circuit according to claim 1, wherein the image-processing die 1 is a CCD sensor.

4. The image-processing integrated circuit according to claim 1, wherein the conductive layer 2 is attached to the image-processing die 1 by a through-silicon via technique.

5. The image-processing integrated circuit according to claim 1, wherein the first and second optical units 3, 4 are convex lenses.

6. The image-processing integrated circuit according to claim 1, wherein the first and second optical units 3, 4 are concave lenses.

7. The image-processing integrated circuit according to claim 1, wherein the first and second optical units 3, 4 are Fresnel lenses.
